(19) United States
(12) Patent Application Publication
(10) Pub. No.: US 2015/0113766 A1
(43) Pub. Date: Apr. 30, 2015

(54) ROLLER WHEEL FOR LUGGAGE

(71) Applicant: I-SHUN HOU, Taipei City (TW)

(72) Inventor: I-SHUN HOU, Taipei City (TW)

(21) Appl. No.: 14/061,861

(22) Filed: Oct. 24, 2013

(51) Int. Cl. A45C 13/00; B60B 33/00

(52) U.S. Cl. CPC A45C 13/00; B60B 33/0028
USPC 16/45

(57) ABSTRACT

A roller wheel for luggage is provided. The suitcase has a main body and a plurality of wheel seats on the corners thereof. Each of the wheel seats is defined by a bottom wall and two adjacent side walls, and the wheel is mounted to the wheel seat. The wheel includes a wheel rack, a tyre assembly and a bolt. The rack has a cylindrical hub and a plurality of integrally formed spokes. The hub is rotatably connected to a bent portion formed by the two side walls. The tyre assembly is pivotally mounted to the spokes. The bolt selectively goes through the hub and the wheel seat. The wheel rack rotates about a longitudinal rotation centre of the bolt with respect to the wheel seat, and the rotation centre is proximate to the bent portion of the two side walls.

### BACKGROUND

1. Field of the Invention

The instant disclosure relates to a roller wheel; in particular, to a simplified roller wheel for luggage.

2. Description of Related Art

Roller wheels are often installed to the bottom surface of luggage bags/suitcases to increase the mobility thereof. However, conventional luggage bags often require as many as four to six screws to fasten a roller wheel (or a roller retaining seat of a roller wheel) onto the bag body thereof. The use of multiple screws inherently translates to higher manufacturing complexity and assembling difficulty, and moreover requires increased usage of raw materials and thus induces higher manufacturing costs. Moreover, for conventional wheeled luggage bags that utilize screw-fastened roller retaining seats, when the luggage bag is subjected to external impact, the screw-retained roller seat thereof is often damaged or detached, making it difficult to repair.

Therefore, it is of great desire within the industry to reduce/resolve the abovementioned issue through improved structural design. Specifically, it is desirable to provide a roller assembly for luggage bags that is simple by design, easy to install, robust in structural integrity, and convenient to remove/detach, at the same time having reduced likelihood of suffering external damage due to rough handling of the luggage bags during transport. To address the above issues, the inventor strives via associated experience and research to present the instant disclosure, which can effectively improve the limitation described above.

### BRIEF SUMMARY OF THE INVENTION

The instant disclosure provides a roller wheel for luggage which is easy to be assembled or disengaged and has simplified structure. The roller wheel is relatively silent and smooth when it is in motion.

According to one exemplary embodiment of the instant disclosure, a roller wheel for luggage is provided. The suitcase has a main body and a plurality of wheel seats on the corners thereof. Each of the wheel seats is defined by a bottom wall and two adjacent side walls, and the wheel is mounted to the wheel seat. The roller wheel includes a wheel rack including a cylindrical hub and a plurality of integrally formed spokes. The hub is rotatably connected to a bent portion formed by the two side walls of the wheel seat. The roller wheel also includes a tyre assembly including a first tyre and a second tyre. The first tyre and the second tyre are respectively, pivotally mounted to two lateral sides of the spokes. Further, the roller wheel includes a bolt selectively going through the hub and the wheel seat. The wheel rack rotates about a longitudinal rotation centre of the bolt with respect to the wheel seat, and the rotation centre is proximate to the bent portion of the two side walls.

In summary, the conventional wheel seat is replaced by the bent portion of the main body of the luggage. The bent portion serves as the wheel seat while optimizing the structural strength. The overall assembly process is therefore simplified, and wheel seat detachment is less likely to occur when external forces hit. Moreover, the rotation axis is positioned to the outer most edge of the corners, such that the main body is not prone to tilt when the wheel rotate. The tyre skin is made of thermerplastic or thermalset plastic, so as to offer better traction and provide better capability against heat, pressure or erosion.

In order to further understand the instant disclosure, the following embodiments are provided along with illustrations to facilitate the appreciation of the instant disclosure; however, the appended drawings are merely provided for reference and illustration, without any intention to be used for limiting the scope of the instant disclosure.

### BRIEF DESCRIPTION OF THE SEVERAL VIEWS OF THE DRAWINGS

FIG. 1 is a perspective view of a roller wheel for luggage in accordance with an embodiment of the instant disclosure;

FIG. 2 is an exploded view of a roller wheel for luggage in accordance with an embodiment of the instant disclosure;

FIG. 3 is another exploded view of a roller wheel for luggage in accordance with an embodiment of the instant disclosure;

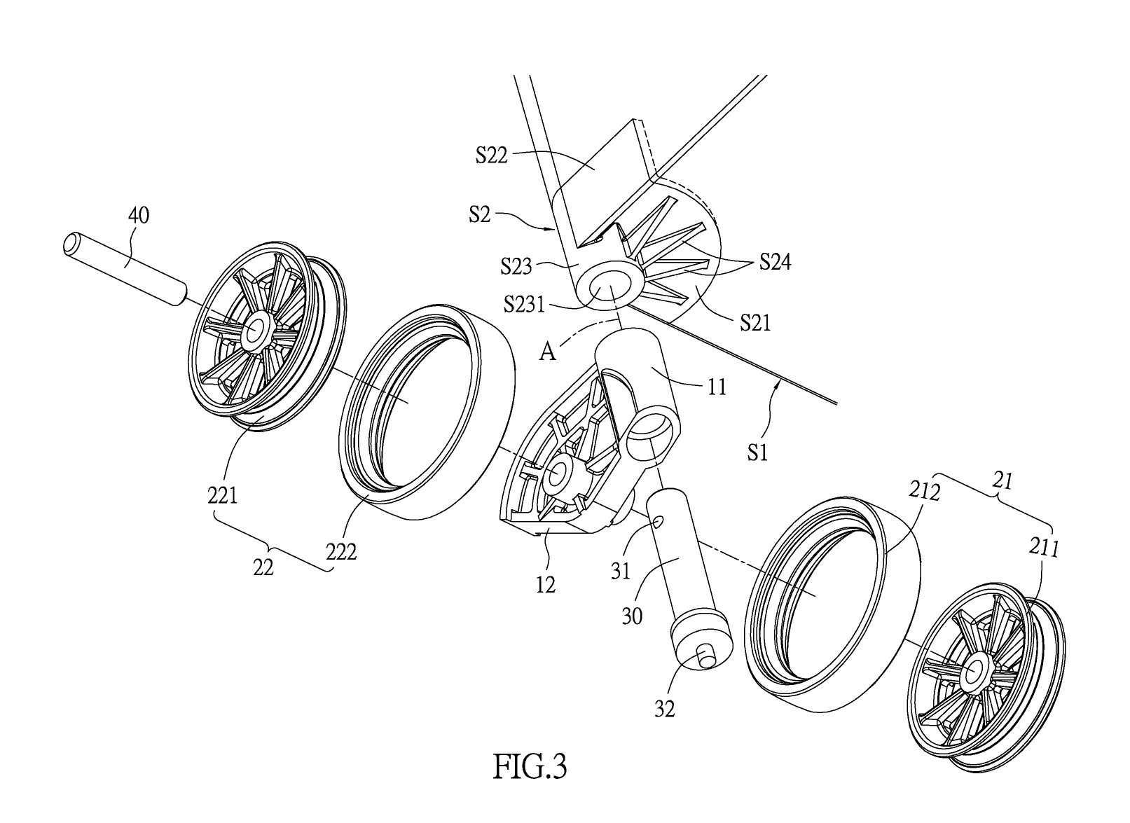

FIG. 4 is a top view of a roller wheel for luggage in accordance with an embodiment of the instant disclosure;

FIG. 5 is a side view of a roller wheel for luggage in accordance with an embodiment of the instant disclosure;

FIG. 6 is a cross-sectional view of a roller wheel for luggage in accordance with an embodiment of the instant disclosure; and

FIG. 7 is a cross-sectional view along line A-A in FIG. 5.

### DETAILED DESCRIPTION OF THE INVENTION

The aforementioned illustrations and following detailed descriptions are exemplary for the purpose of further explaining the scope of the instant disclosure. Other objectives and advantages related to the instant disclosure will be illustrated in the subsequent descriptions and appended drawings.

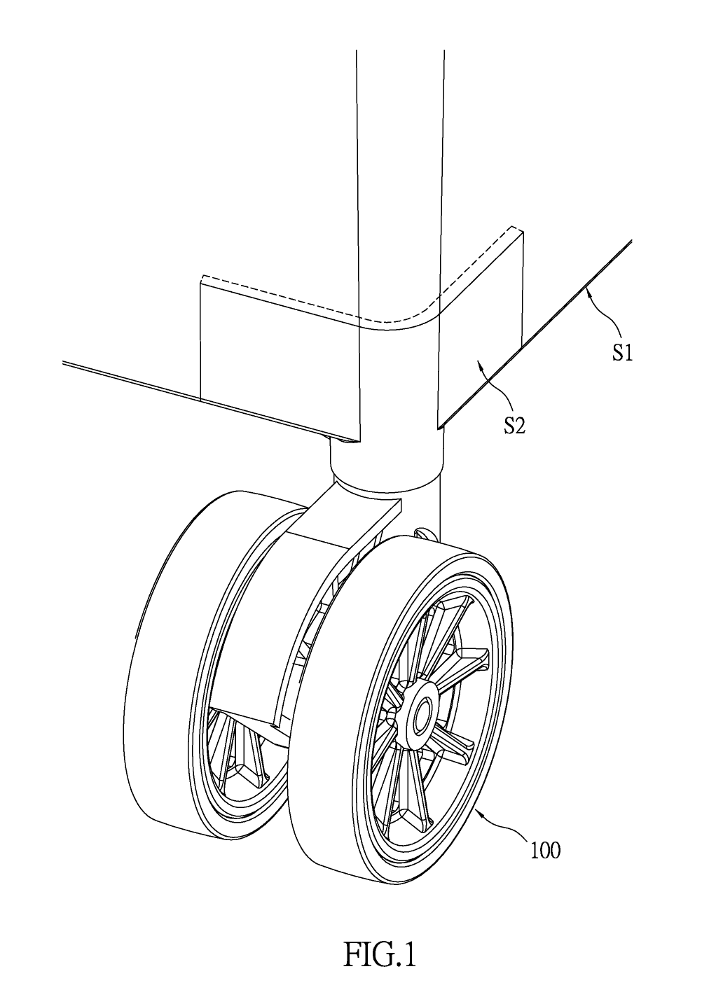

Please refer to FIG. 1. The instant disclosure provides a roller wheel 100 for luggage. The luggage has a main body S1 and at least one wheel seat S2 disposed on the main body S1 for receiving the roller wheel 100. The main body S1 may be in any shape and size. For example, a main body for a travelling suitcase. The main body S1 is preferably made of thermalplastic material yet the instant disclosure is not limited thereto. The roller wheel 100 is mounted to the main body S1. In other words, the roller wheel 100 sits on the wheel seat S2, and the wheel seat S2 is preferably integrally formed on the top or bottom corners of the main body S1. Each of the wheel seat S2 has a bottom wall S21 and two adjacent side walls S22. (For clarity, only one wheel seat S2 is shown in the figure.) Furthermore, the wheel 100 can also be adapted to conventional wheel seat.

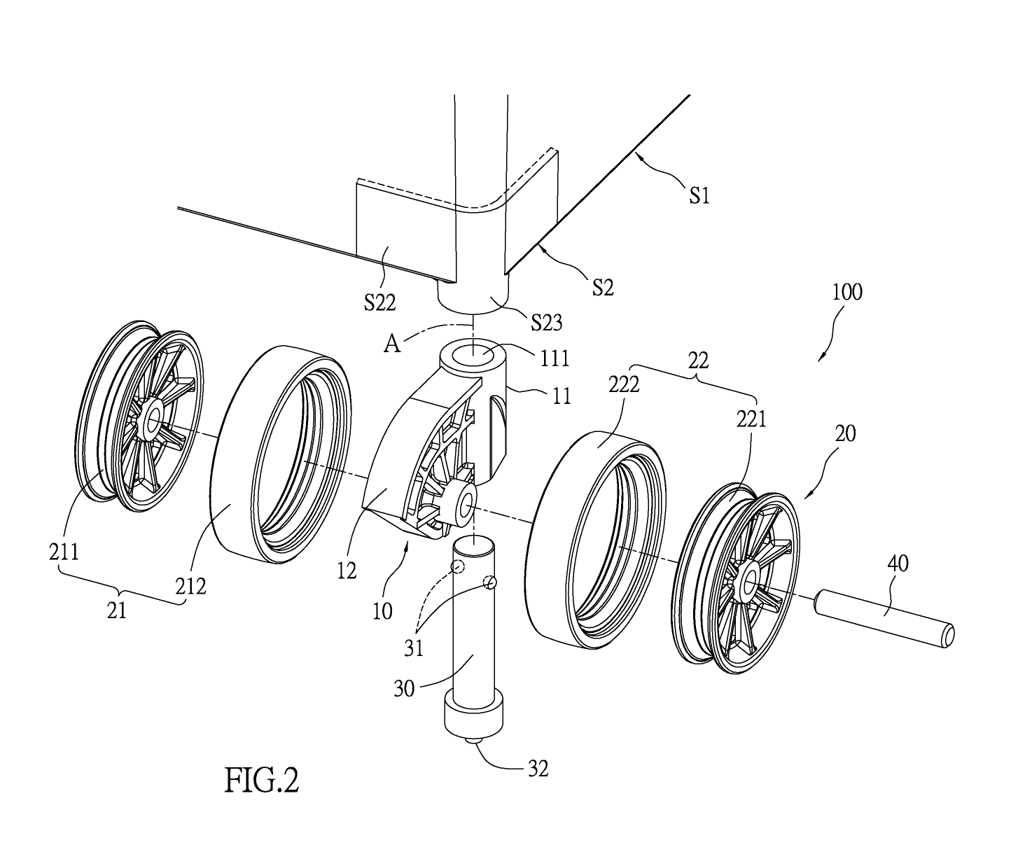

Please refer to FIGS. 1, 2 and 4. The roller wheel 100 includes a wheel rack 10, a tyre assembly 20 and a bolt 30. The wheel rack 10 has a substantially cylindrical hub 11 and a plurality of spokes extending therefrom. The hub 11 is rotatably connected to the bottom of a bent portion where the two side walls S22 of the wheel seat S2 meet. The tyre assembly 20 is pivotally connected to the spokes 12. The bolt 30 goes through the hub 11 and the wheel seat S2 at the corner of the case S1.

More specifically, a connection portion S23 is formed at the bent portion where the two side walls S22 meet and longitudinally extends toward the hub 11. An axial hole or a protrusion is formed at one end of the connection portion S23, and the top end of the hub 11 is formed with a protrusion or a thru hole corresponding to the axial hole or the protrusion of the connection portion S23. In this regard, the hub 11 can rotate about the wheel seat S2. In the instant embodiment, the centre portion of the top end of the hub 11 is formed with a thru hole 111. The centre portion of the bottom end of the connection portion S23 is formed with an axial hole S231. The thru hole 111 and the axial hole S231 of the connection portion S23 are co-axially arranged. The bolt 30, which is detachable, goes through firstly the thru hole 111 and then the axial hole S231 of the connection portion S23, such that the hub 11 and the connection portion are interconnected.

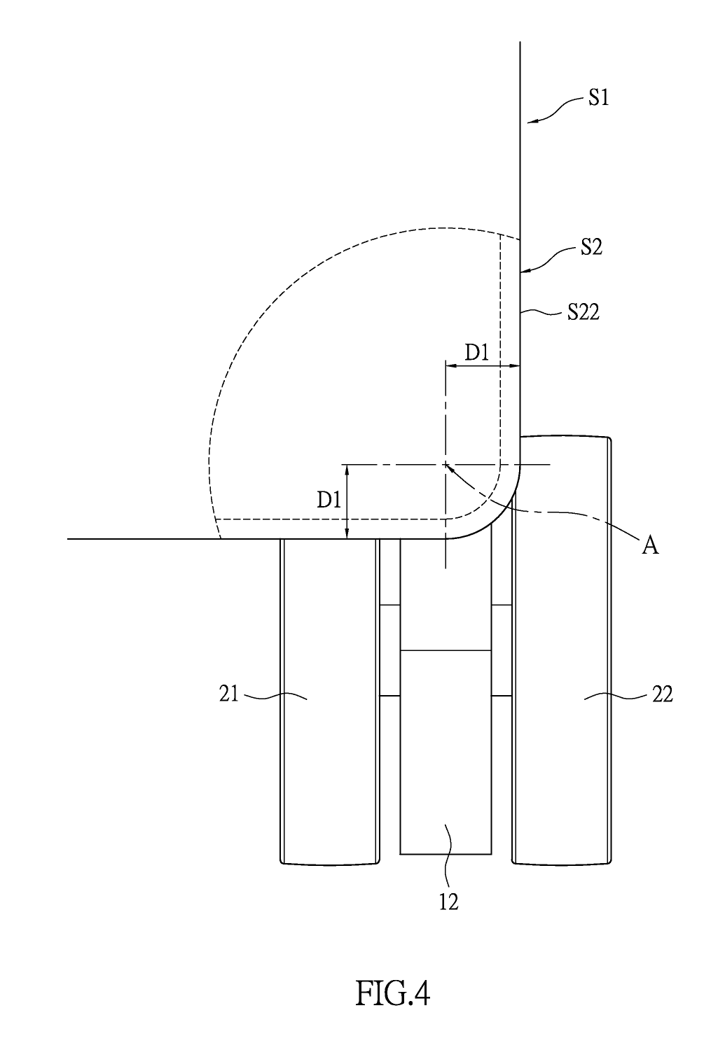

Further still, the bolt 30 in the instant embodiment is a fast detached bolt. At least one steel ball tenon 31 is disposed at the premier of the top end of the bolt. (Only two steel balls are shown in the figure yet the number is not limited to the instant embodiment.) The bolt 30 has a button 32 disposed at the centre portion of the bottom end for releasing the steel ball tenons 31. Thus the roller wheel 100 can be released from the case S1 by pressing the button 32 which then disengage the steel ball tenons 31. In other words, the roller wheel 100 can be fast assembled and detached from the suitcase S1. The wheel rack 10 can rotate along a longitudinal rotation axis A of the bolt 30 with respect to the wheel seat S2. The rotation axis A is proximate to the bent portion where the two side walls S22 of the wheel seat S2 meet. That is to say, the rotation axis A is positioned to the outer most corner edge of the main body S1. Preferably, an orthogonal distance D1 from the rotation axis A to the outer face of the two side walls S22 measures between 9 to 13 millimeters (as shown in FIG. 4). Moreover, a plurality of supporting ribs fans out from the connection portion S23 and the bent portion of the bottom wall S21.

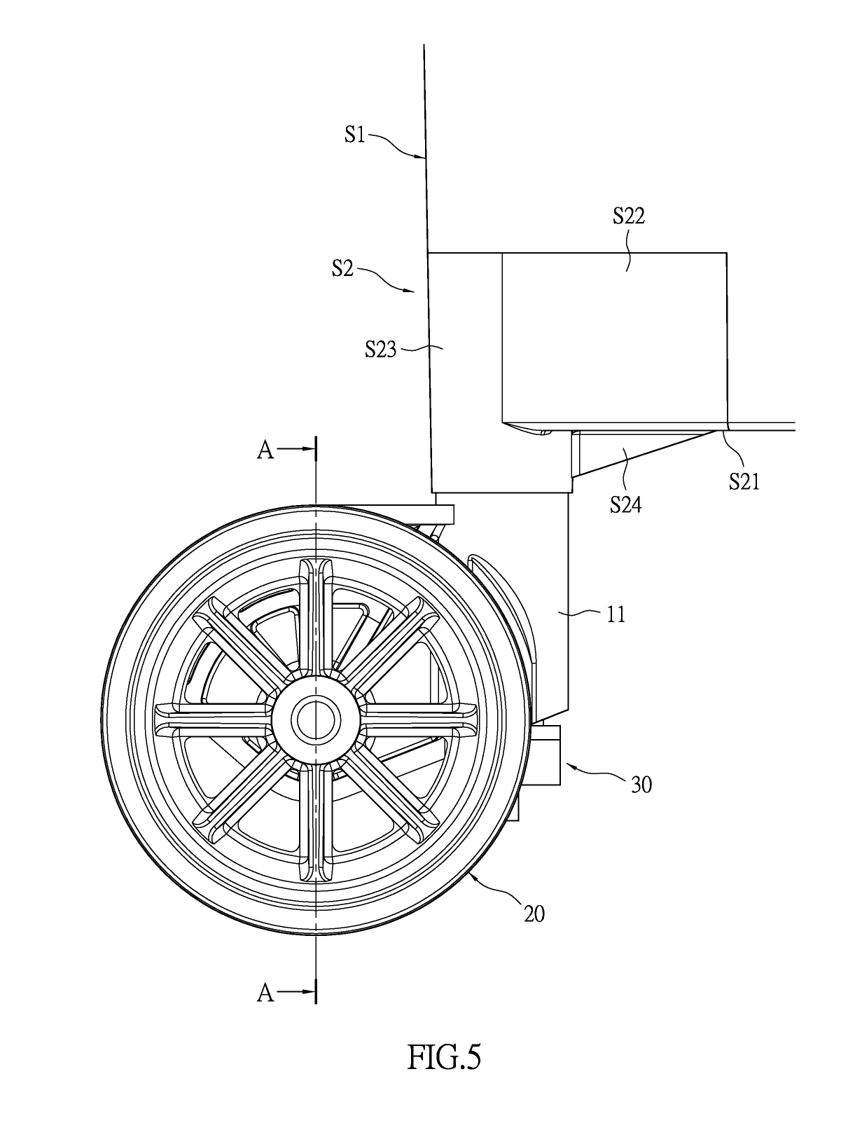

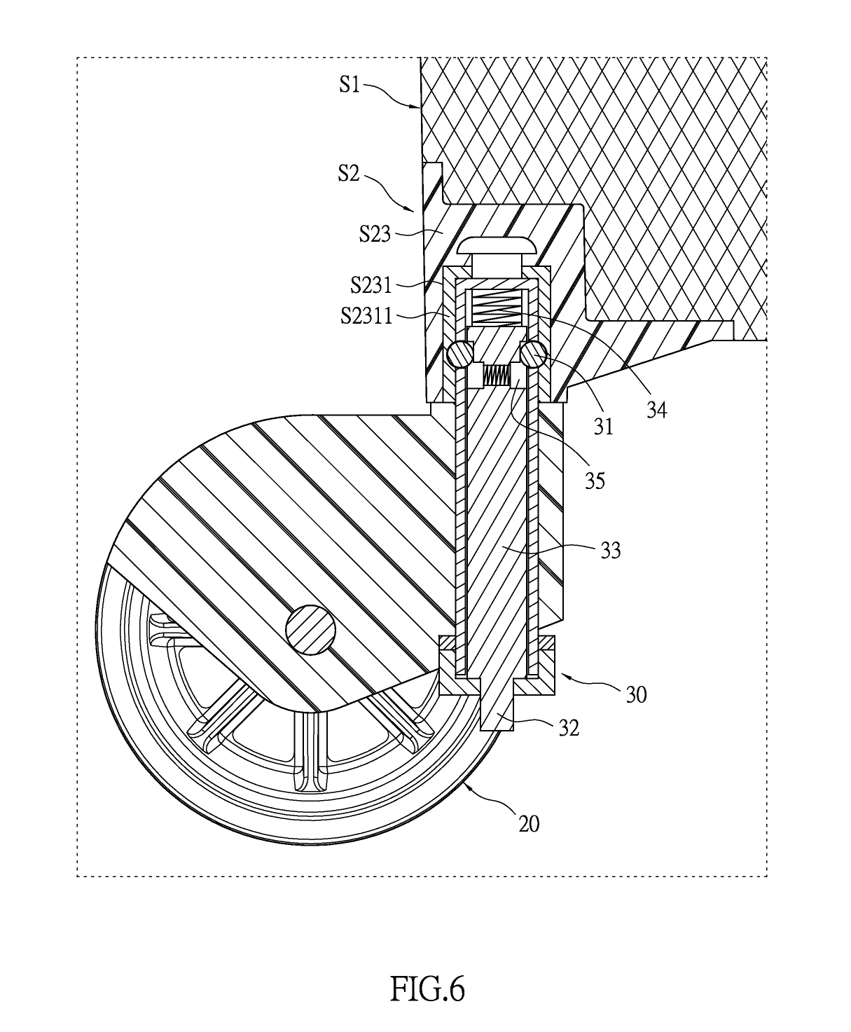

Please refer to FIGS. 5 and 6. A hollow cylindrical metallic bore S2311 is mounted within the axial hole S231 of the connection portion S23. The metallic bore S2311 provides more resistance to the metal coated bolt 30 when it goes through the axial hole S231. At the same time, the steel ball tenon 31 also abuts against the metallic bore S2311. The bolt 30 has a driving shaft 33 and a spring 34. The button 32 is connected to the bottom the driving shaft 33, and the spring 34 is connected to the top of the driving shaft 33. The driving shaft 33 is formed with a groove 35 for receiving the steel ball tenon 31. When the button 32 is pressed, the driving shaft 33 is actuated and compresses the spring 34, and then the steel ball tenon 31 disengages. The steel ball tenon 31 then slides in the groove 35, and therefore the bolt 30 is demounted.

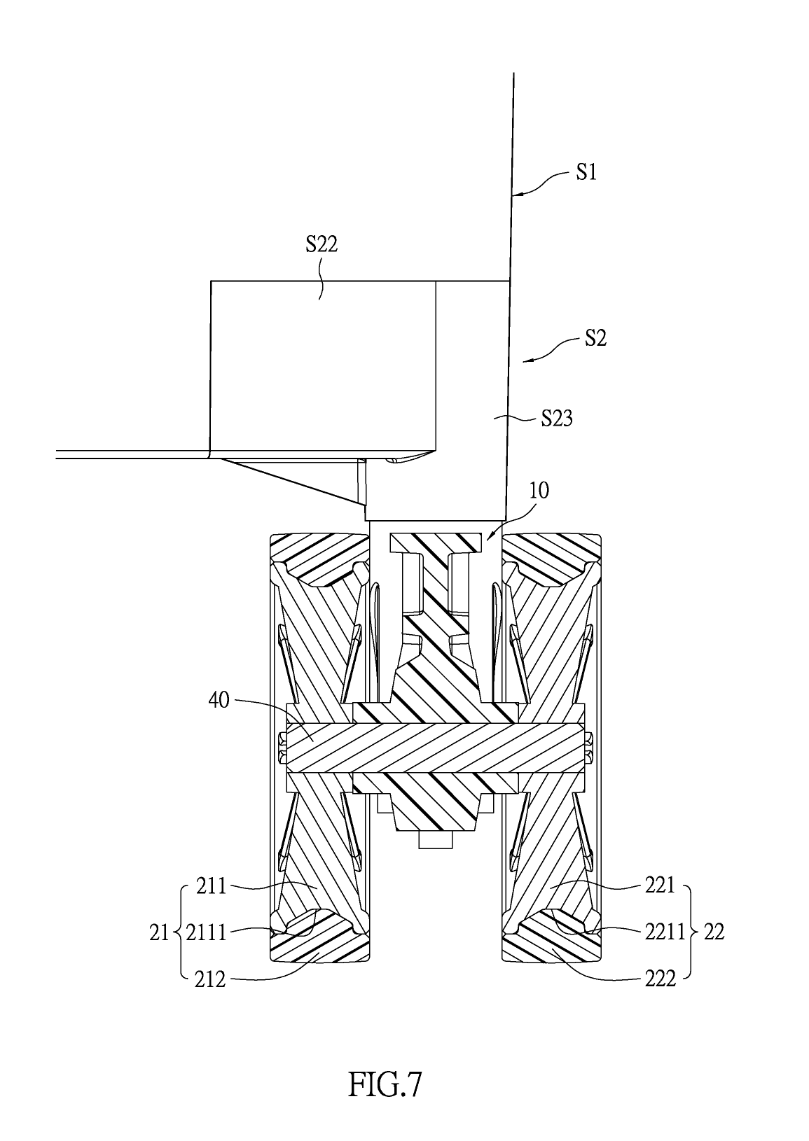

Please refer to FIGS. 5 and 7. The tyre assembly 20 includes a tyre (or a first tyre) and another tyre (or a second tyre). The first tyre 21 has a first tyre frame 211 and a first tyre skin 212. The first tyre skin 212 sleeves the first tyre frame 211. In addition, the outer perimeter of the first tyre frame 211 is formed with a first annular groove 2111. When the first tyre 212 sleeves the first tyre frame 211, the edge of the first tyre skin 212 is tucked into the first annular groove 2111. Likewise, the second tyre 22 has a second tyre frame 221 and a second tyre skin 222. The second tyre skin 222 sleeves the second tyre frame 221. In addition, the outer perimeter of the second tyre frame 221 is formed with a second annular groove 2211. When the second tyre skin 222 sleeves the second tyre frame 221, the edge of the second tyre skin 222 is tucked in the second annular groove 2211. The first and second tyre skins 212, 222 are preferable made of thermalplastic or thermalset material yet the instant disclosure is not limited thereto. The relief is similar to normal car tyre design for a betting gripping. When rolling, the tyre is steady with minimum noisy generated by vibration.

In assembly, the first and second tyres 21, 22 are pre-assembled and combine with the spokes of the wheel rack 10 by a rivet 40. Once it is done, the roller wheel 100 pre-assembly is complete. By pressing the button 32 of the bolt 30, the driving shaft 33 compresses the spring 34, the steel ball tenon 31 of the bolt 30 is loosened, and the steel ball tenon 31 slides into the groove 33. Then the bolt 30 goes through the thru hole 111 of the hub 11 and the axial hole S231 at the corner of the wheel seat S2. After the bolt 30 goes all the way down the thru hole 111 of the hub 11 and the axial hole S213 of the wheel seat S2, the button 32 can be releases. Subsequently, the steel ball tenon 31 abuts the metallic bore S2311 embedded within the axial hole S231 of the connection portion S23. The assembly of the roller wheel 100 to the main body S1 is then complete. In the instant embodiment, the bolt 30 is detachable, while in another embodiment, the bolt 30 may be fixed.)

In short, the instant disclosure provides a roller wheel for luggage. Compared to the conventional roller wheel, the roller wheel of the instant disclosure does not need a plurality of screws to assemble the wheel seat onto the case. Therefore the roller wheel of the instant disclosure is highly effective in time wise. Meanwhile, the case does not employ the conventional wheel seat. The case main body can receive the roller wheel. In other words, the overall structural strength is greatly enhanced, and wheel seat breakage or screw detachment can be avoided. The roller wheel of the instant embodiment can be fast detached by pressing the button on the bolt. The assembly process is simplified, and package space is greatly reduced. As a result, the transportation efficiency is also elevated. The repair is made easier because of the easy detachment of the roller wheel. In addition, the rotation axis of the roller wheel is positioned at the outer most corner of the main body, such that when the roller wheel rolls, it is less likely to tilt. The tyre skin can be made of thermalplastic material or thermalset material which allows stable and silent motion.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A roller wheel for a suitcase, the suitcase having a main body and a plurality of wheel seats on corners thereof, each of the wheel seats defined by a bottom wall and two adjacent side walls, the wheel mounted to the wheel seat, comprising:
a wheel rack including a cylindrical hub and a plurality of integrally formed spokes, wherein the hub is rotatably connected to a bent portion formed by the two side walls of the wheel seat;
a tyre assembly including a first tyre and a second tyre, wherein the first tyre and the second tyre are respectively, pivotally mounted to two lateral sides of the spokes; and
a bolt selectively going through the hub and the wheel seat;
wherein the wheel rack rotates about a longitudinal rotation centre of the bolt with respect to the wheel seat, and the rotation centre is proximate to the bent portion of the two side walls.

2. The roller wheel according to claim 1, wherein the bent portion between the two side walls of the wheel seat has a longitudinal connection portion stretching toward the hub, and the connection portion and the hub are connected.

3. The roller wheel according to claim 2, wherein a centre region at one end of the hub is formed with a thru hole, a centre region at one end of the connection portion is formed with an axial hole, the thru hole and the axial hole share the same axis, and the bole goes through the thru hole and the axial hole.

4. The roller wheel according to claim 2, wherein the connection portion and bottom portion of the wheel seat close to the bent portion have a plurality of supporting ribs fanning out.

5. The roller wheel according to claim 1, wherein the bolt is fast detached, a steel ball tenon is disposed at the premier at one end of the bolt, the centre region of the other end of the bolt has a button to release the steel ball tenon, and the wheel is detachable from the wheel seat by pressing the button.

6. The roller wheel according to claim 1, wherein the first tyre has a first tyre frame and a first tyre skin, the premier of the first tyre frame is formed with a first annular groove, the first tyre skin sleeves the first tyre frame, and the edge of the first tyre skin is tucked into the first annular groove.

7. The roller wheel according to claim 1, wherein the second tyre has a second tyre frame and a second tyre skin, the premier of the second tyre frame is formed with a second annular groove, the second tyre skin sleeves the second tyre frame, and the edge of the second tyre skin is tucked into the second annular groove.
